(19) United States
(12) Patent Application Publication
(10) Pub. No.: US 2006/0064843 A1
(43) Pub. Date: Mar. 30, 2006

(54) Paint roller tray for placing on a paint container

(76) Inventor: Rudolphus Johannes Adrianus Maria Cornelissen, Schaijk (NL)

Correspondence Address: LAW OFFICES OF ERIC KARICH, 2807 ST. MARK DR., MANSFIELD, TX, 76063, US

(21) Appl. No.: 11/272,630

(22) Filed: Nov. 14, 2005

(30) Foreign Application Priority Data
May 15, 2003 (NL) 1023418
May 19, 2003 (NL) 1023467
Jun. 16, 2003 (NL) 1023673
Jul. 24, 2003 (NL) 1023986
Dec. 30, 2003 (NL) 1025151
May 14, 2004 (WO) PCT/NL04/00336

(51) Int. Cl. B05C 21/00

(52) U.S. Cl. 15/257.06

(57) ABSTRACT

A paint roller tray is made from one piece of plastic and has a rectangular bottom with a raised edge, which edge stops along one side. The paint roller tray, furthermore, has two flexible arms, one on each side of the place where the raised edge stops. Each arm is provided with a means of coupling made up of two flexible hooks for coupling the paint roller tray to a paint tin. When the paint roller tray is on the paint tin, the side where the raised edge stops is situated above an opening in the top of the paint tin. Here, the hooks grip the rim of the paint tin.

### BACKGROUND OF THE INVENTION

1. Field of the Invention

The invention relates to a paint roller tray for placing on a paint container, in particular a paint tin or paint bucket, which paint roller tray is provided with a bottom having a raised edge running along at least a part of its periphery, which stops at a point, above an opening situated in the top of the paint container when the paint roller tray is placed on a paint container, which paint roller tray, furthermore, comprises a means of coupling, for coupling the paint roller tray to a paint container, in such a way that it can also be detached, especially to the rim of an opening in the paint container.

Paint roller trays are used for painting with paint rollers. The paint roller can be dipped directly into the paint, in the paint container, and then rolled over the bottom of the paint roller tray in order to spread the paint over the roller and remove any excess paint from it. Here, the excess paint flows back through the opening into the paint container. In this way, it is not necessary to put the paint in the paint roller tray first, as is the case with paint roller trays which cannot be placed on a paint container and which are provided with a receptacle for the paint.

2. Prior Art

A paint roller tray of the type described in the preamble is known from the American patent U.S. Pat. No. 5,472,111. This known paint roller tray is provided with two flexible handles on the underside, which extend downwards, on which there are projections for coupling the paint roller tray to the rim of a paint bucket. Because these handles are short and the projections are small and rigid, this known paint roller tray is only suitable for use in combination with a paint container provided with an opening and a rim for which the handles with projections have been designed.

### SUMMARY OF THE INVENTION

An objective of the invention is to provide a paint roller tray of the type described in the preamble which can be fitted on different paint containers. To this end, the paint roller tray according to the invention is characterized in that the paint roller tray comprises at least one flexible arm, in which the means of coupling is situated near or on the free outer end of the arm. Because of this flexible arm, the paint roller tray can be coupled to paint containers of which the shape of the rim and the size of the opening may vary.

In order to be able to couple the paint roller tray simply to a paint container, an embodiment of the paint roller tray according to the invention is characterized in that the arm, as viewed in a direction perpendicular to the bottom, extends beyond the bottom. The arm preferably is attached to the raised edge and/or the bottom at or near an end of the raised edge where the raised edge stops.

Furthermore, the raised edge preferably extends from the bottom to at least two edges opposite each other, and the place where the raised edge stops preferably extends from the bottom along an additional edge, in which the paint roller tray preferably comprises an additional flexible arm, where an arm is situated on either side of the place where the raised edge stops, which preferably is attached to the raised edge and preferably is an extension of the raised edge.

A further embodiment of the paint roller tray is characterized in that the means of coupling comprises at least one flexible hook, for hooking onto, in, behind or under a paint container's rim. With this, a simple construction is obtained with which the paint roller tray can be coupled to a rim having almost any shape. Preferably, the hook is situated in the surface of the arm.

In order to be able to fit the paint roller tray on a paint container even better, the means of coupling preferably comprises at least one additional flexible hook, in which the free outer ends of the hooks are aimed in opposite directions, preferably towards each other.

Still a further embodiment of the paint roller tray is characterized in that the bottom at the place where the raised edges stops is provided with an edge especially for removing excess paint from a paint brush, which edge is provided with notches.

Again, a further embodiment of the paint roller tray is characterized in that the raised edge is provided with at least one opening for holding a paint roller or paint brush, which opening is preferably stepped in order to be able to hold the handles of paint brushes or paint rollers of various sizes.

The paint roller tray preferably is made from one piece, preferably plastic.

A further embodiment of the paint roller tray according to the invention which is less expensive to manufacture than the previously described embodiments is characterized in that the raised edge comprises a back wall and two side walls and that the paint roller tray is made from a flat sheet which can be folded and is provided with a bottom section, which after being folded forms the bottom part, and three wall sections, which form the walls after being folded.

In order to fix the walls in a simple way, an embodiment of the paint roller tray according to the invention is characterized in that the wall section forming the back wall is provided with projecting parts, which after being folded extend beyond the side walls, and which are provided with openings in which the side walls hook with their upper edge after being folded.

In order to fold the paint roller tray simply and easily from the sheet, a further embodiment of the paint roller tray according to the invention is characterized in that there are additional folding lines in the back wall in continuation of the folding line between the side walls and the bottom part, and, furthermore, in that there are additional folding lines between the vertices of the bottom part, which abut the back wall and the nearby vertices of the side walls between the back wall and the side walls. In this embodiment, the openings preferably abut the additional folding lines and preferably extend outwards from the additional folding lines.

The paint roller tray, which can be folded, according to the invention can, in contrast with the embodiments with flexible arms described previously, also be executed as a generally known paint roller tray with one half in which paint can be put and one half which is provided with a surface for rolling off excess paint that lies higher than the bottom of the half mentioned first. Should the paint roller tray be executed as such a paint roller tray, still a further embodiment of the paint roller tray according to the invention is characterized in that the paint roller tray comprises a second bottom part, which is situated lower than the other bottom part, as well as a bottom wall situated between the two bottom parts, and two additional side walls and a front wall, and that the sheet comprises an additional bottom section, as well as a bottom wall section situated between the two bottom sections and three additional wall sections. There are additional folding lines between the bottom wall and the two bottom parts, as well as between the additional bottom part and the additional side walls and front wall, and in the front wall in continuation of the folding lines between the additional bottom part and the additional side walls, and between the vertices of the additional bottom part abutting the front wall and the nearby corners of the additional side walls and the front wall, and in which the front wall is provided with additional projecting parts, which after being folded extend beyond the additional side walls, and which are provided with additional openings in which after being folded the additional side walls hook into with their upper edge.

A further embodiment of the paint roller tray which again is executed as a paint roller tray for placing on a paint container provided with flexible arms and without a part in which paint can be put, is characterized in that the paint roller tray's arms are extensions of the side walls, and that the sheet, moreover, comprises two arm sections, which are an extension of and are attached to the wall sections forming the side walls.

With this embodiment the free outer ends of the arm sections preferably are provided with flexible hooks, for hooking behind and/or under a paint container's rim.

Furthermore, with this embodiment the arms are provided with holes near the free outer ends, as well as gaps which run from the holes to the edges of the arms, for hooking onto a flange round the opening of a paint container.

Finally, with this embodiment, the bottom preferably at the fourth edge is provided with an edge which can be folded down for removing excess paint from a paint brush, which edge is provided with notches.

### BRIEF DESCRIPTION OF THE DRAWINGS

The invention will be elucidated more fully below by means of examples of embodiments of the paint roller tray according to the invention shown in the drawings. Shown are:

FIG. 1: a view from above of a first embodiment of the paint roller tray according to the invention;

FIG. 2: a side view of the paint roller tray shown in FIG. 1;

FIG. 3: a rear view of the paint roller tray shown in FIG. 1;

FIG. 4: the paint roller tray shown in FIG. 1 situated on a first type of paint tin;

FIG. 5: the paint roller tray shown in FIG. 1 situated on a second type of paint tin;

FIGS. 6, 7 and 8: a second embodiment of the paint roller tray according to the invention shown in a view from above, a side view and a front view respectively;

FIGS. 9, 10 and 11: a third embodiment of the paint roller tray according to the invention shown in a view from above, a side view and a front view respectively;

FIGS. 12, 13 and 14: a fourth embodiment of the paint roller tray according to the invention shown in a view from above, a side view and a front view respectively;

FIGS. 15, 16 and 17: a fifth embodiment of the paint roller tray according to the invention shown in a view from above, a side view and a front view respectively;

FIGS. 18 and 19: a first embodiment of the paint roller tray that can be folded from a flat sheet shown before being folded and after being folded respectively;

FIGS. 20 and 21: a second embodiment of the paint roller tray that can be folded from a flat sheet shown before being folded and after being folded respectively; and

FIGS. 22, 2 and 24: a third embodiment of the paint roller tray that can be folded from a flat sheet shown before being folded and after being folded respectively in a view from above and a view from below respectively.

### DETAILED DESCRIPTION OF THE DRAWINGS

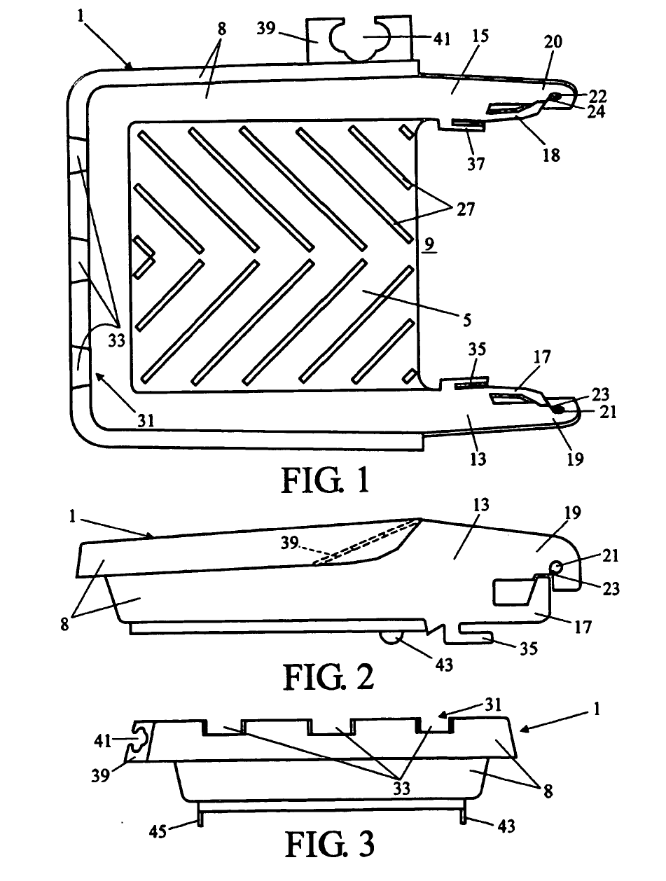

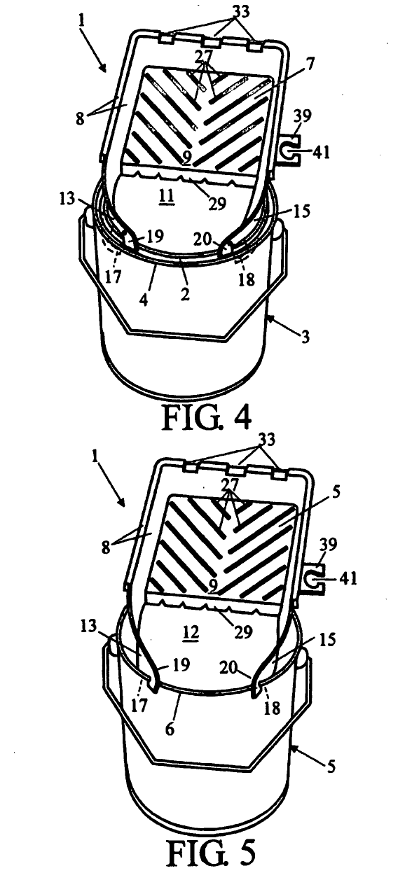

In FIGS. 1, 2 and 3, a first embodiment of the paint roller tray 1 according to the invention is shown in a view from above, a side view and rear view respectively, and in FIGS. 4 and 5 the paint roller tray 1 is shown situated on a first type of paint tin 3 and a second type of paint tin 5. The paint roller tray 1 is made from one piece of plastic and has a rectangular bottom 7 with a raised edge 8, which extends along three sides and stops at a fourth side 9. The place where the raised edge stops 9 is situated above an opening 11, 12 in the top of the paint tin 3, 5 when the paint roller tray 1 is situated on a paint tin 3, 5; see FIGS. 4 and 5.

Furthermore, the paint roller tray 1 has two flexible arms 13 and 15, one on each side of the place where the raised edge stops 9. The arms 13, 15 extend beyond the bottom, as viewed in a direction perpendicular to the bottom 7, and are an extension of the raised edge 8 to which they are attached. Each arm is provided with a means of coupling which is made up of two flexible hooks 17, 19 and 18, 20. The hooks 17, 19 and 18, 20 are situated in the surface of the arms 13 and 15 and the outer ends of the hooks 17 and 19, 18 and 20 respectively are turned towards each other. When the paint roller tray 1 is fitted on the paint tin 3, the rim 2 of a paint tin 3 of the first type is clamped between these hooks 17, 19and 18,20.

The hooks 19 and 20 are provided with holes 21 and 22 and gaps 23, 24 which run from the holes to an edge of the arms; see FIGS. 1 and 2. These holes 21 and 22 are especially for hooking onto a flange 6 round the opening 12 of another type of paint tin. This is shown in FIG. 5 where the paint roller tray 1 is situated on this paint tin 5 and in which the rim round the opening consists of a flange 6 bent outwards.

The bottom 7 of the paint roller tray 1 is provided with ridges 27 in order to be able roll a paint roller over it better and, the place where the raised edge stops 9, is provided with an edge 29 with notches for removing excess paint from a paint brush.

The paint roller tray 1, moreover, is provided with openings 33 of various sizes in the rearmost part 31 of the raised edge 7, for holding paint rollers or paint brushes.

On the underside of each arm 13, 15 there is a flexible lip 35, 37 in which a stirrer can be clamped. Furthermore, there is a holder 39 provided with an opening 41 for hanging a paint brush, situated on the raised edge.

On the underside of the raised edge 8 are two projections 43, 45 which when the paint roller tray 1 is being used are brought in contact with the inner rim 2 or the outer rim 4 of the paint tin 3 in order to obtain a more stable positioning of the paint roller tray 1 on the paint tin 3.

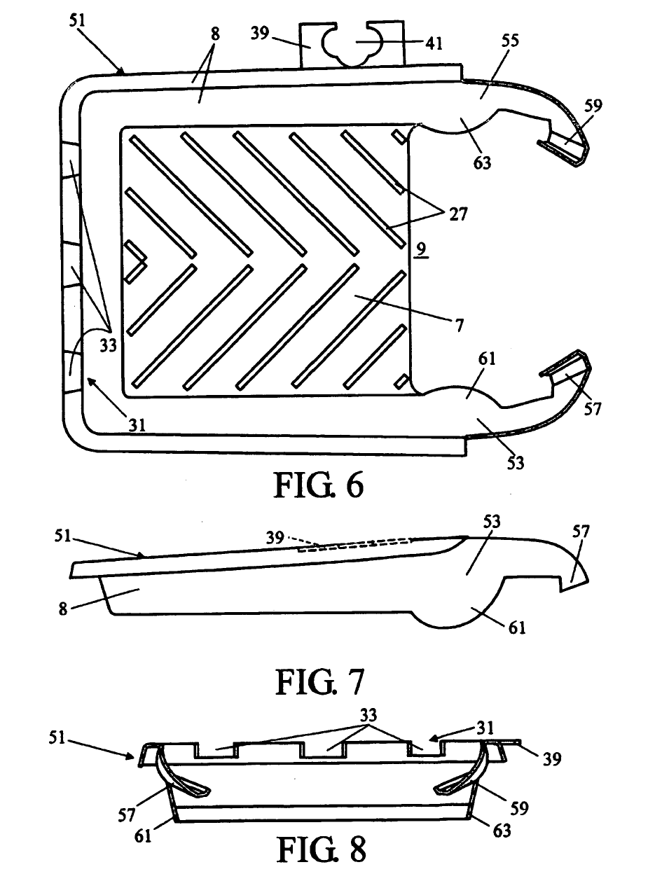

In FIGS. 6, 7 and 8 a second embodiment of the paint roller tray 51 according to the invention is shown in a view from above, a side view and a front view respectively. All parts which are the same or have the same function as those of the first embodiment are indicated by the same reference numbers. With this embodiment of the paint roller tray 51, the arms 53, 55 and the hooks 57, 59 have a different shape. The hooks 57, 59 can be hooked here behind a bucket's outer rim. This paint roller tray 51 is therefore particularly suitable for use on paint buckets. There are flaps 61, 63 on the arms 53, 55 which when placing the paint roller tray 51 on a paint bucket are situated against the inner rim of the opening at the top of the paint bucket in order to give the paint roller tray more stability.

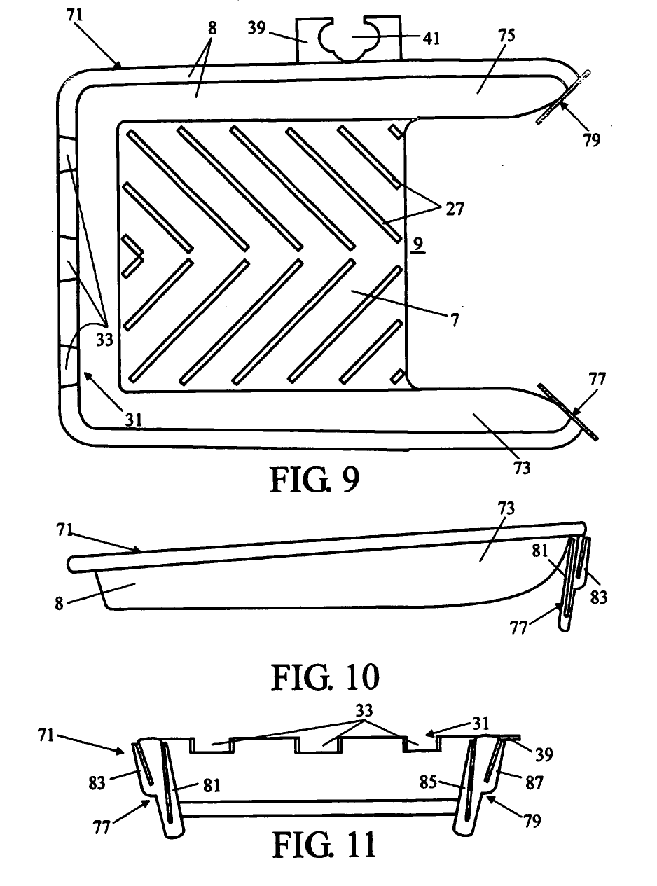

In FIGS. 9, 10 and 11 a third embodiment of the paint roller tray 71 according to the invention is shown in a view from above, a side view and a front view respectively. Here as well, all parts which are the same or have the same function as those of the first embodiment are indicated by the same reference numbers. With this embodiment of the paint roller tray 71, the arms 73, 75 and the hooks 77, 79 again have a different shape. The hooks 77, 79 are executed here as double hooks 81, 83 and 85, 87, which again can also be hooked onto the outer rim of a bucket. Depending on the height of the outer rim of the bucket, the largest hook 81, 85 or the smallest hook 83, 87 or both can be used. With this embodiment, the hooks 77, 79 are situated transversely on the outer ends of the arms 73, 75.

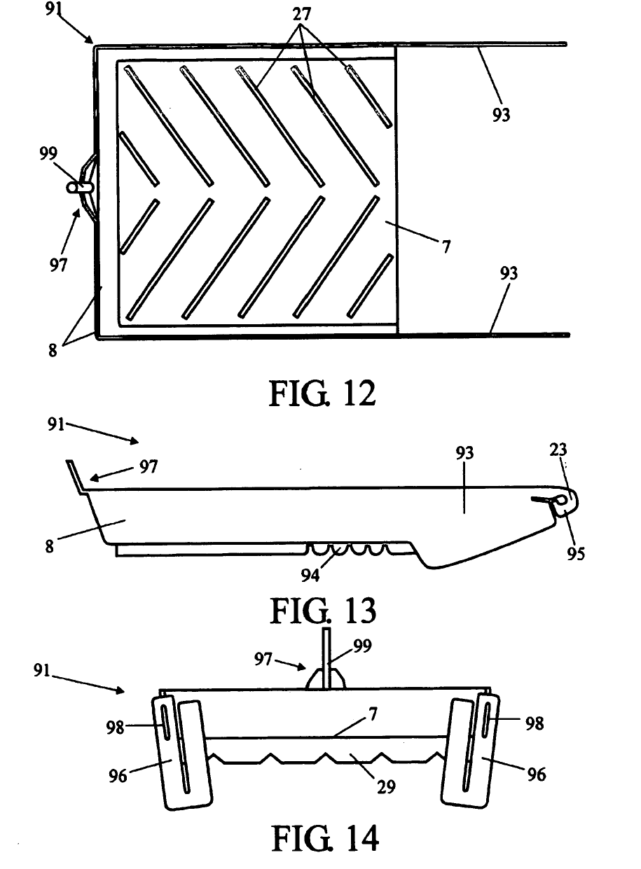

Furthermore, in FIGS. 12, 13 and 14 a fourth embodiment of the paint roller tray 91 according to the invention is shown in a view from above, a side view and a front view respectively. Here as well, all parts which are the same or have the same function as those of the first embodiment are indicated by the same reference numbers. With this embodiment of the paint roller tray 91, the arms 93 and the hooks 95 again have a different shape. In this embodiment, the hooks 95 again can also be hooked behind the outer rim of a bucket.

There are a number of teeth 94 on the underside of the paint roller tray 91. When placing the paint roller tray 91 on a paint container, the paint container's rim is clamped between two adjacent teeth. Because of this, the paint roller tray 91 can be placed in different positions on the rim of a paint container.

This paint roller tray 91 is provided with a pen 99 on a projecting part 97 of the raised edge 8, on which the handle of a paint roller can be hung.

Should a paint bucket have a high rim on the outer side of the opening, the hook 95 can no longer be hooked onto the rim. In order to still be able to use the paint roller tray 91 with paint containers having high rims an auxiliary hook 96 can be hooked behind the hook 95; see FIG. 14. This auxiliary hook 96 is situated transversely on the end of the arm 93 and is provided with a slot 98 which can be placed over the hook 95.

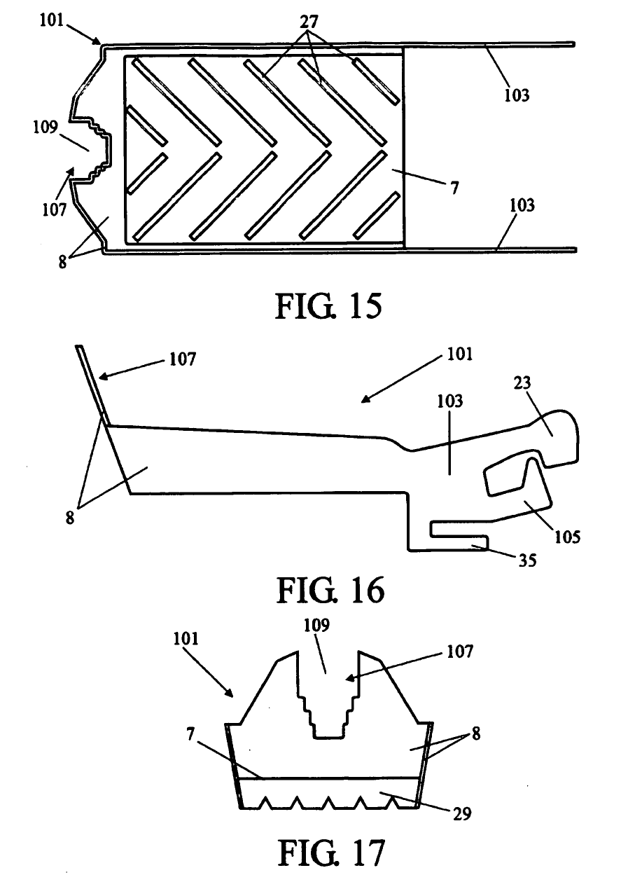

In FIGS. 15, 16 and 17 a fourth embodiment of the paint roller tray 101 according to the invention is shown in a view from above, a side view and a front view respectively. Here also, all parts which are the same or have the same function as those of the first embodiment are indicated by the same reference numbers. With this embodiment of the paint roller tray 101, the arms 103 and the hooks 105 again have a somewhat different shape because this paint roller tray 101 is suitable for fitting on small paint tins of one litre. In addition, the arms 103 of this paint roller tray 101 can be shoved along the rim of a paint tin so that the position of the tray with respect to the opening in the paint tin can be adjusted.

An additional important difference of this paint roller tray 101 with respect to the paint roller tray 1 shown in FIGS. 1 to 3 inclusive is the shape of the opening 109 in the elevated part 107 of the raised edge 8. The opening 109 is stepped as a result of which paint rollers or paint brushes having handles of different diameters can be held.

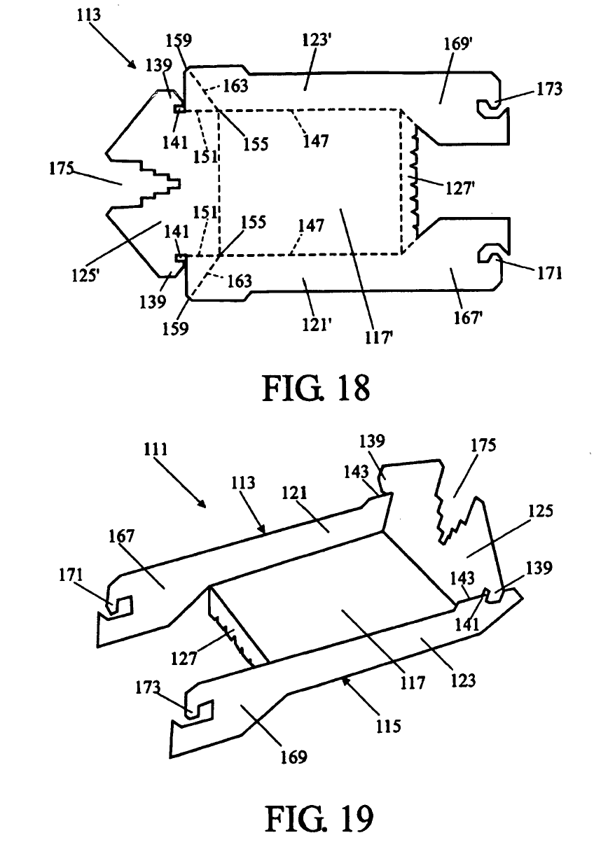

In FIGS. 18 and 19 a first embodiment of the paint roller tray according to the invention, which can be folded from a flat sheet, is shown before being folded and after being folded. This paint roller tray 111 is made from one flat sheet 113 that can be folded. The paint roller tray has a receptacle 115 provided with a rectangular bottom part 117 that is enclosed by two side walls 121 and 123, a back wall 125 and an edge 127 provided with notches for removing any excess paint from a paint brush.

The sheet 113 has a bottom section 117′, which after being folded forms the bottom part 117, three wall sections 121′, 123′ and 125′, which after being folded form the side walls 121 and 123 and the back wall 125, and a section 127′ which after being folded forms the edge for removing excess paint 127. The wall section 125′ which forms the back wall 125, is provided with projecting parts 139, which after being folded extend beyond the side walls, and are provided with openings 141 in which after being folded the side walls hook with their upper edge 143.

In order to be able to fold the sheet 113 easily, there are additional folding lines 151 in the back wall which are a continuation of the folding lines 147 between the side walls and the bottom part, and there are additional folding lines 163 between the vertices 155 abutting the back wall of the bottom part and the nearby vertices 159 of the side walls.

With this embodiment the paint roller tray 111, furthermore, has two arms 167 and 169, which are an extension of the side walls 121 and 123, and the sheet 113 has two arm sections 167′ and 169′, which are extensions of and are attached to the wall sections 121′ and 123′ which form the side walls. The free outer ends of the arm sections, after being folded, are a part of the means of coupling for coupling the paint roller tray to a paint container in such a way that it can also be detached, especially to a rim of an opening in a paint tin or paint bucket. This means of coupling is made up of flexible hooks 171 and 173, which are a part of the arms, for hooking onto, in, behind or under a paint container's rim.

In the back wall 125 there is a stepped opening 175 in which a paint brush or paint roller can be placed by its handle. Here as well, the bottom part 117 may be provided with ridges which protrude upwards (not shown).

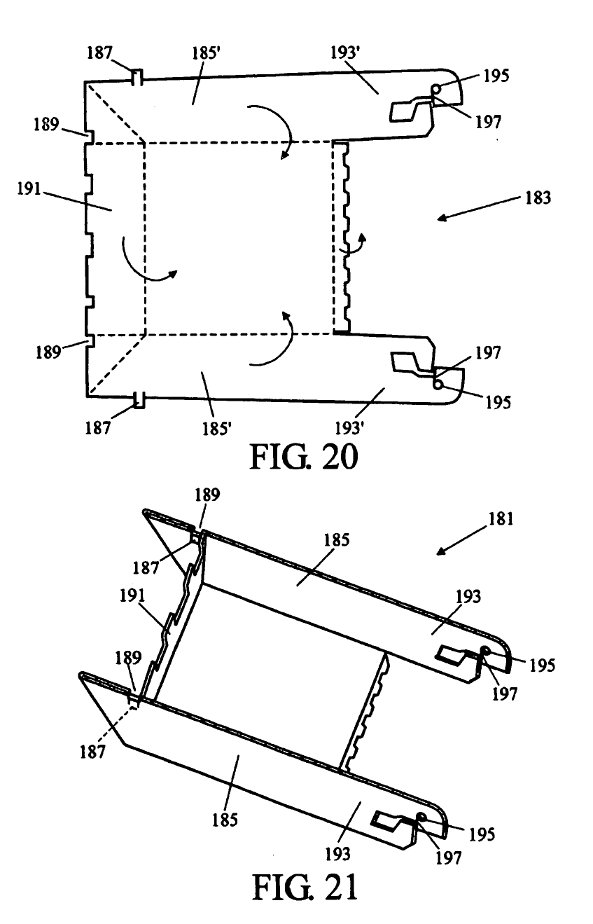

In FIGS. 20 and 21, a second embodiment of the paint roller tray 181 is shown, which can be folded from a flat sheet, before being folded 183 and after being folded respectively. The wall sections 185′ which form the side walls 185 are, in this embodiment, provided with projecting tabs 187 which can be folded down in the openings 189 situated in the wall section 191′ which forms the back wall 191.

The arm sections 193′ which form the arms 193, moreover, are provided with holes 195 near the free outer ends and gaps 197 run from the holes to the edges of the arms for hooking onto a flange round the paint container's opening.

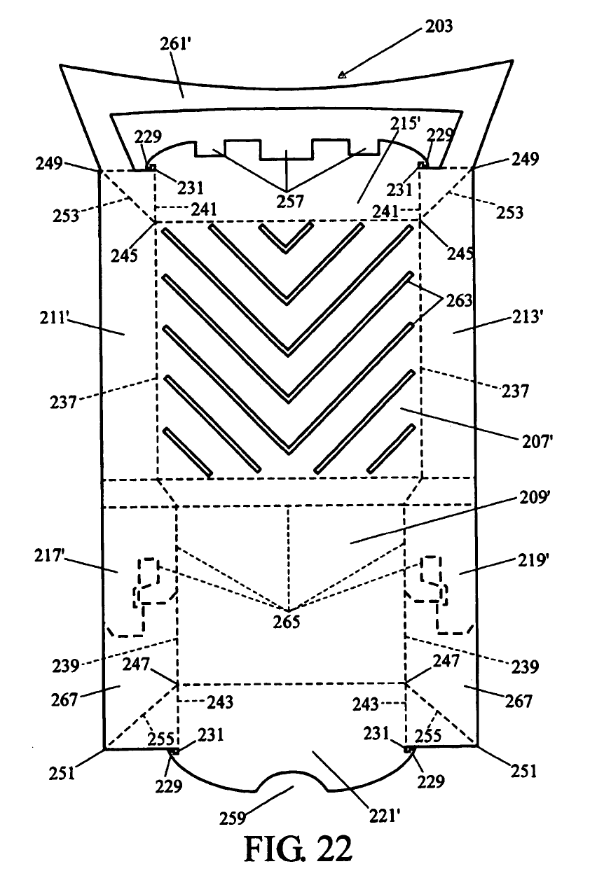

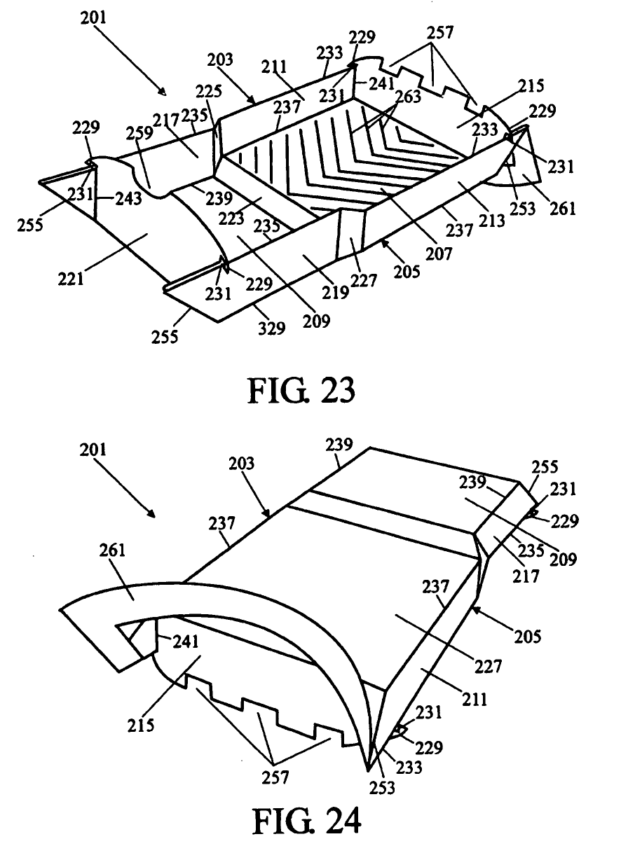

In FIGS. 22, 23 and 24 a third embodiment of the paint roller tray 201 which can be folded from a flat sheet, is shown before being folded and after being folded respectively, in a view from above and a view from below respectively. The paint roller tray 201 is made from one flat sheet 203 which can be folded. The sheet 203 is made of plastic, for example, and is provided with folding lines which have been made beforehand and which are formed by making the sheet thinner or by cutting into the sheet. The sheet can also be made from other materials, such as cardboard which may or may not be plasticized on one or both sides.

The paint roller tray 201 has a receptacle 205 provided with two rectangular bottom parts 207, 209. One of the bottom parts 207 is enclosed by two side walls 211, 213 and a back wall 215. The other bottom part 209 is enclosed by two additional side walls 217, 219 and a front wall 221. A bottom wall 223 is situated between the two bottom parts 207 and 209 and the connecting walls 225, 227 are situated between the side walls 211, 213 and the additional side walls 217, 219.

The sheet 203 has two bottom sections 207′, 209′, which after being folded, form the bottom parts 207, 209, three wall sections 211′, 213′ and 215′, which after being folded form the side walls 211, 213 and the back wall 215, and three additional wall sections 217′, 219′ and 221′, which after being folded form the additional side walls 217, 219 and the front wall 221. The wall sections 221′ and 215′ which form the front and back walls 221 and 215, are provided with projecting parts 229, which after being folded extend beyond the side walls 211, 213 and additional side walls 217, 219, and are provided with openings 231 in which the side walls and additional side walls hook with their upper edges 233 and 235.

In order to be able to fold the sheet 203 easily, there are additional folding lines 241, 243 in the front and back walls which are a continuation of the folding lines 237 and 239 between the side walls and the additional side walls on the one side and the two bottom parts on the other side. The openings 231 abut these additional folding lines 241 and 243 and extend from these additional folding lines outwards. Furthermore, between the vertices 245 and 247 of both bottom parts, which abut the front and rear walls, and the nearby vertices 249 and 251 of the side walls there are additional folding lines 253 and 255 between the front and back walls and the side walls.

In the front and back walls 215, 221 are a number of openings 257, 259 in which paint brushes and paint rollers can be put by their handles. Furthermore, the sheet has a U-shaped projection 261′ which after being folded is a support 261 under the higher-lying bottom part 207. This bottom part 207 acts as a surface for rolling off the excess paint on a paint roller and for this purpose is also provided with ridges 263 which protrude upwards. The other bottom part 209 forms the bottom of a container in which paint can be put into which a paint roller can be dipped.

The sheet 203 is also provided with a pre-cut tearing line 265. The sheet can easily be torn along this tearing line, as a result of which the wall section 221′ with the bottom section 209′ and parts 267 of the additional wall sections 217′ and 219′ can be removed from the rest of the sheet, after which one has a paint roller tray which is comparable to the embodiment described above.

Although in the above the invention is explained on the basis of the drawings, it should be noted that the invention is in no way limited to the embodiments shown in the drawings. The invention also extends to all embodiments deviating from the embodiments shown in the drawings within the context defined by the claims. Thus the paint roller tray according to the invention can be used not only for paint, but glue as well. Furthermore, the holes 21, 22 and the gaps 23, 24 of the first embodiment may also be omitted because paint tins with flanges are being used less and less.

1. A paint roller tray for placing on a paint container, in particular a paint tin or paint bucket, the paint roller tray comprising:
a bottom having a raised edge running along at least a part of its periphery, which stops at a point, above an opening situated in the top of the paint container when the paint roller tray is placed on a paint container; and
a means of coupling the paint roller tray to a paint container, in such a way that it can also be detached, especially to the rim of an opening in the paint container, characterized in that the paint roller tray comprises at least one flexible arm, on which the means of coupling is situated at or near the free end of the arm.

2. The paint roller tray according to claim 1, characterized in that the arm extends beyond the bottom, as viewed in a direction perpendicular to the bottom.

3. The paint roller tray according to claim 2, characterized in that the arm is attached to the raised edge and/or bottom at or near an end of the raised edge where the raised edge stops.

4. The paint roller tray according to claim 3, characterized in that the raised edge preferably extends from the bottom to at least two edges opposite each other and the place where the raised edge stops extends from the bottom along an additional edge, and that the paint roller tray comprises an additional flexible arm, in which there is an arm on each side of the place where the raised edge stops which is attached to the raised edge and is an extension of the raised edge.

5. The paint roller tray according to claim 4, characterized in that the means of coupling comprises at least one flexible hook, for hooking onto, in, behind or under a paint container's rim.

6. The paint roller tray according to claim 5, characterized in that the hook is situated in the surface of the arm.

7. The paint roller tray according to claim 5, characterized in that the means of coupling comprises at least one additional flexible hook, where the free outer ends of the hooks are aimed in opposite directions, preferably towards each other.

8. The paint roller tray according to claim 4, characterized in that the bottom where the raised edge stops, is provided with an edge for removing any excess paint from a paint brush, which edge is provided with notches.

9. The paint roller tray according to claim 4, characterized in that the raised edge is provided with at least one opening for holding a paint roller or paint brush, which opening is preferably stepped.

10. The paint roller tray according to claim 4, characterized in that the paint roller tray is made from one piece, preferably plastic.

11. The paint roller tray according to claim 4, characterized in that the raised edge comprises a back wall and two side walls and that the paint roller tray is made from a flat sheet that can be folded provided with a bottom section, which after being folded forms the bottom part, and three wall sections situated on the three edges of the bottom section, which form the walls after being folded.

12. The paint roller tray according to claim 11, characterized in that the wall section forming the back wall is provided with projecting parts, which after being folded extend beyond the side walls, and which are provided with openings into which the side walls hook with their upper edge after being folded.

13. The paint roller tray according to claim 12, characterized in that there are additional folding lines in continuation of the folding line between the side walls and the bottom part in the back wall.

14. The paint roller tray according to claim 13, characterized in that the openings abut the additional folding lines and extend outwards from the additional folding lines.

15. The paint roller tray according to claim 14, characterized in that between the back wall and the side walls there are additional folding lines between the vertices of the bottom part abutting the back wall and the nearby vertices of the side walls.

16. The paint roller tray according to claim 11, characterized in that the paint roller tray comprises a second bottom part, which is situated lower than the other bottom part, as well as a bottom wall situated between the two bottom parts, and two additional side walls and a front wall, and that the sheet comprises an additional bottom section, as well as a bottom wall section between the two bottom sections and three additional wall sections, and in which there are additional folding lines between the bottom wall and the two bottom parts, as well as between the additional bottom part and the additional side walls and front wall, and in the front wall in continuation of the folding lines between the additional bottom part and the additional side walls, and between the vertices of the additional bottom part abutting the front wall and the nearby corners of the additional side walls and the front wall, and in which the front wall is provided with additional projecting parts, which after being folded extend beyond the additional side walls, and which are provided with additional openings in which after being folded the additional side walls hook into with their upper edge.

17. The paint roller tray according to claim 11, characterized in that the paint roller tray's arms are an extension of the side walls, and that the sheet, moreover, comprises two arm sections, which are an extension of and are attached to the wall sections which form the side walls.

18. The paint roller tray according to claim 17, characterized in that the free outer ends of the arm sections comprise flexible hooks, for hooking behind and/or under a paint container's rim.

19. The paint roller tray according to claim 4, characterized in that the arms are provided with holes near the free outer ends, as well as gaps which run from the holes to the edges of the arms, for hooking onto a flange round a paint container's opening.

20. The paint roller tray according to claim 11, characterized in that the bottom at the fourth edge is provided with an edge which can be folded down for removing excess paint from the paint brush, and which edge is provided with notches.
